(19) United States
(12) Patent Application Publication
(10) Pub. No.: US 2023/0161582 A1
(43) Pub. Date: May 25, 2023

(54) DEVICES, SYSTEMS AND METHODS FOR SECURELY STORING AND MAINTAINING SCANNER DEVICES

(71) Applicant: THEREALDEALCARS.COM, Santa Cruz, CA (US)

(72) Inventors: Greg Nickel, Aptos, CA (US); Deckard Pham, San Jose, CA (US)

(21) Appl. No.: 17/534,402

(22) Filed: Nov. 23, 2021

(51) Int. Cl. G06F 8/65

(52) U.S. Cl. CPC G06F 8/65

(57) ABSTRACT

A method can include providing a plurality of physical ports for on-board diagnostic (OBD) type scanners in a secure storage system, the physical ports not being accessible when the secure storage system is locked; by operation of an unlocking procedure, unlocking the secure storage system to enable physical access to the plurality of physical ports; receiving at least one on-board diagnostic (OBD) type scanner at one of the physical ports of the secure storage system; and in response to a predetermined request data frame from the at least one OBD type scanner, generating a response data frame for reception by the OBD type scanner that includes at least one data field that identifies the secure storage system. Corresponding devices and systems are also disclosed.

### BACKGROUND

Modern automobiles are equipped with on-board diagnostic (ODB) capability. OBD systems can provide status data on various sub-systems of an automobile. OBD data can be accessed at an OBD port via a scanner. Currently, automobiles sold in the United States of America are compatible with the OBD-II specification, while gasoline automobiles sold in Europe are compatible with the EOBD standard. As such, OBD-II and EOBD automobiles are equipped with a physical port to which an OBD scanner can be connected.

OBD scanners can provide valuable sub-system data for evaluating automobile performance and/or diagnosing automobile problems. Some OBD scanners can take the form of a “dongle” (i.e., a relatively small device with physical connector) that can communicate wirelessly (i.e., Bluetooth) with an evaluation device. Further, some OBD scanners are equipped with additional capabilities, including other wireless communication (e.g., WiFi, cellular) and position location, including GPS, GSM and network-based location.

### BRIEF DESCRIPTION OF THE DRAWINGS

FIGS. 1A to 1E are diagrams showing a secure scanner storage system according to embodiments.

FIG. 2 is a side cross sectional view of a secure scanner storage system according to an embodiment.

FIGS. 3A and 3B are block schematic diagrams of scanner storage systems according to embodiments.

FIGS. 4A, 4B-0 and 4B-1 are diagrams showing secure scanner storage systems according to other embodiments.

FIG. 5 is a diagram showing a tracking system according to an embodiment.

FIG. 6 is a diagram showing operations of a tracking system according to an embodiment.

FIG. 7 is a flow diagram of a secure scanner storage method according to an embodiment.

FIGS. 8A to 8C are diagram showing communications between a scanner and storage system according to embodiments.

FIG. 9 is a flow diagram of scanner storage system operations according to embodiments.

FIG. 10 is a flow diagram of a tracking system method according to an embodiment.

### DETAILED DESCRIPTION

Embodiments disclosed herein can include devices, systems and methods for storing on-board diagnostic (OBD) type scanners in a secure manner, and providing such scanners with data that indicates the scanners secure location.

In some embodiments, stored OBD type scanners can be subject to firmware updates, if needed, including firmware-over-the-air (FOTA) type updates.

In some embodiments, stored OBD type scanners can be subject to health or other functional tests.

In some embodiments, OBD type scanners can be accessed with biometric authentication.

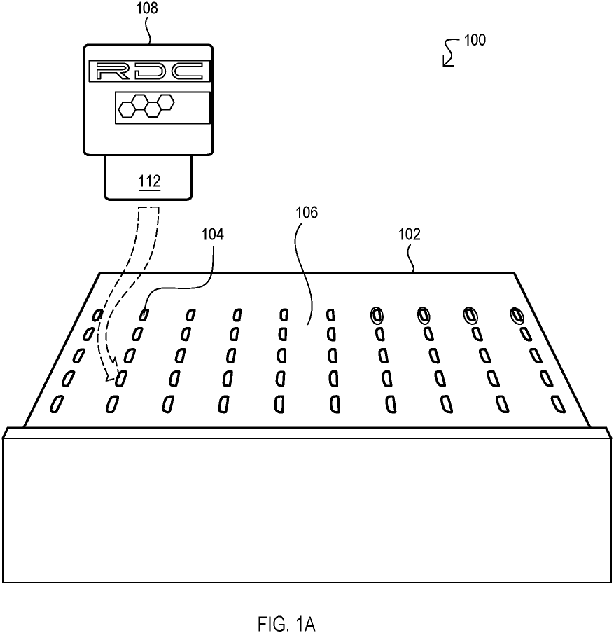

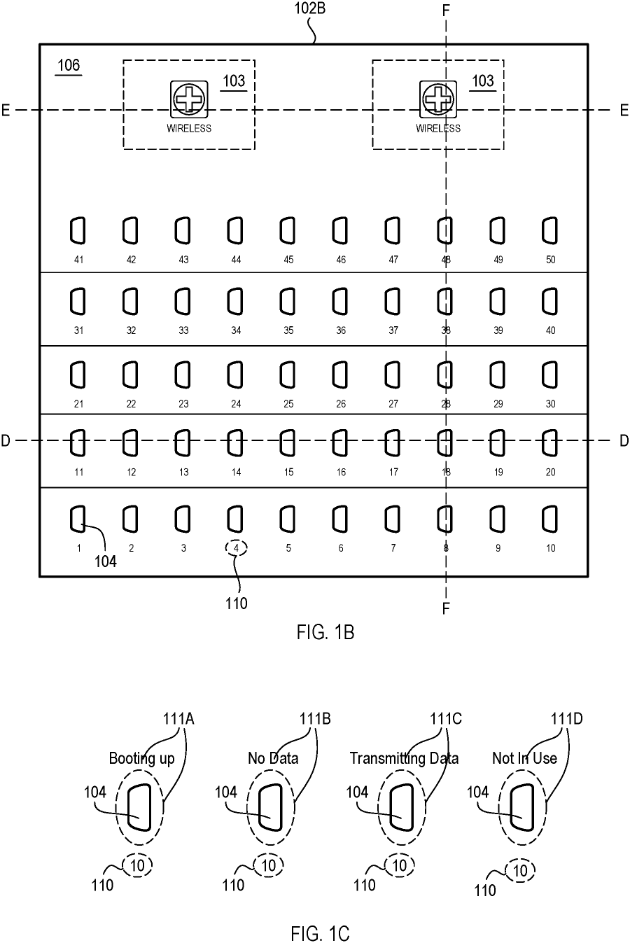

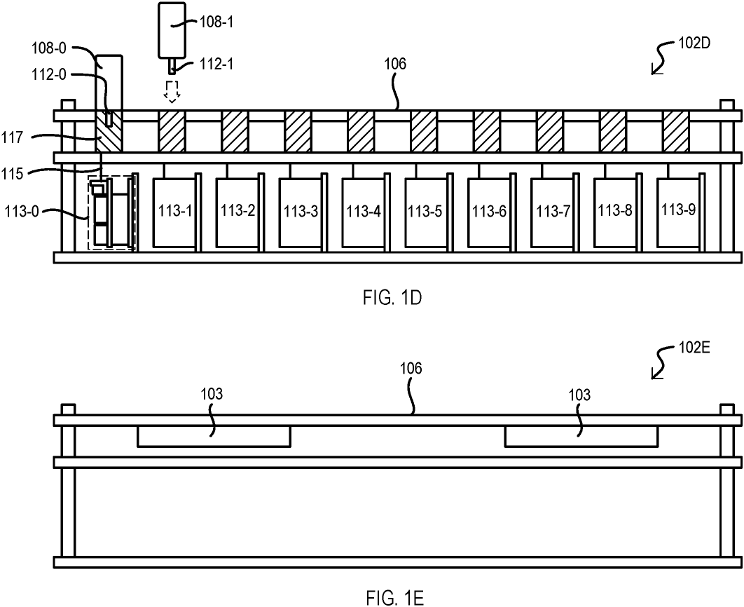

FIG. 1A is a diagram of a storage system 100 according to an embodiment. A storage system 100 can include scanner holder 102, which can store numerous scanners (one shown as 108). A scanner holder 102 can include a surface 106 having a number of physical ports (one shown as 104) set therein. A surface 106 can have any suitable shape. While FIG. 1A shows a flat surface, such an arrangement should not be construed as limiting. Alternate embodiments can include any suitable shape, including an irregular shape.

Physical ports 104 can each receive a scanner (e.g., 108). In some embodiments, physical ports 104 can be female ports compatible with the Society of Automotive Engineers (SAE) J1962 Standard. A scanner holder 102 can include a number of ports sufficient to enable the storing of a large number of scanners (e.g., more than ten). In some embodiments, physical ports 104 can receive OBD type scanners that are employed in conjunction with a fleet of vehicles (e.g., sales, lease), and so involve the rotation of a large number of scanners, as vehicles are received, processed and then removed from a system, facility or the like. In some embodiments, physical ports 104 can be the same type port. However, in other embodiments, physical ports 104 can be different. As but one example, ports can be different to accommodate different types of scanners.

In some embodiments, scanners 108 can be OBD type scanners. OBD type scanners can include scanner compatible with one or more OBD standards, including but not limited to ALDL, OBD-I, OBD-II and EOBD. A scanner 108 can include a connector portion 112 that can make a physical connection with a physical port 104. In some embodiments, a connector portion 112 can a male port compatible with the SAE J1962 Standard. In some embodiments, a scanner 108 can include wireless communication abilities, including but not limited to Bluetooth (BT, including Bluetooth Low Energy, BLE), one or more IEEE 802.11 wireless standards (e.g., WiFi), or any suitable mobile technology (e.g., 3G, 4G, 5G).

FIG. 1B is a top view of a scanner holder 102B according to an embodiment. A scanner holder 102B can be one implementation of that shown in FIG. 1A. A scanner holder 102B can include a number of physical ports as described for FIG. 1A. Standard ports 104 can receive scanners and provide a same functionality as described for FIG. 1A. In some embodiments, such a functionality can include, but is not limited to, a scanner store 102B returning predetermined data in response to request from scanners, executing firmware version checks and updates for scanners, and/or health checks for scanners.

A scanner store 102B can include port identifying information 110 to enable ports to be visually distinguished from one another. In some embodiments, port identifying information 110 can be a text label. However, alternate embodiments can include any other suitable presentation of identifying information, including electronic displays.

FIG. 1C are diagrams showing port identifying information according to an embodiment. A port 104 can have a text label 110 as described herein. In addition, a port 104 can include a light display that can vary according to operating mode. Light displays 111A - 111D can be different colors and can display different text according to mode. Display 111A shows a possible display for a “Booting up” operation. Display 111B shows a possible display for a “No Data” condition. Display 111C shows a possible display for when a scanner is “Transmitting Data”. Display 111D shows a possible display for when port 104 and/or scanner is “Not In Use”. In some embodiments, such displays can include lighted silhouette around the port and/or lighted text indicating the status/mode of the port.

FIG. 1D is a side cross sectional view of a system 102D according to an embodiment. FIG. 1D can be a view taken along line D-D of FIG. 1B. FIG. 1D shows female connectors (one shown as 117) into which scanners can be inserted. A scanner 108-0 is shown in an inserted position. Scanner 108-1 is shown in a removed position. Connectors 117 can each be connected to a port subsystem 113-0 to 113-9 by a communication path (one shown as 115). A communication path 115 can enable signals (including power) to be transmitted between a port subsystem (113-0 to -9) and a scanner (108-0/1) inserted in a corresponding connector 117.

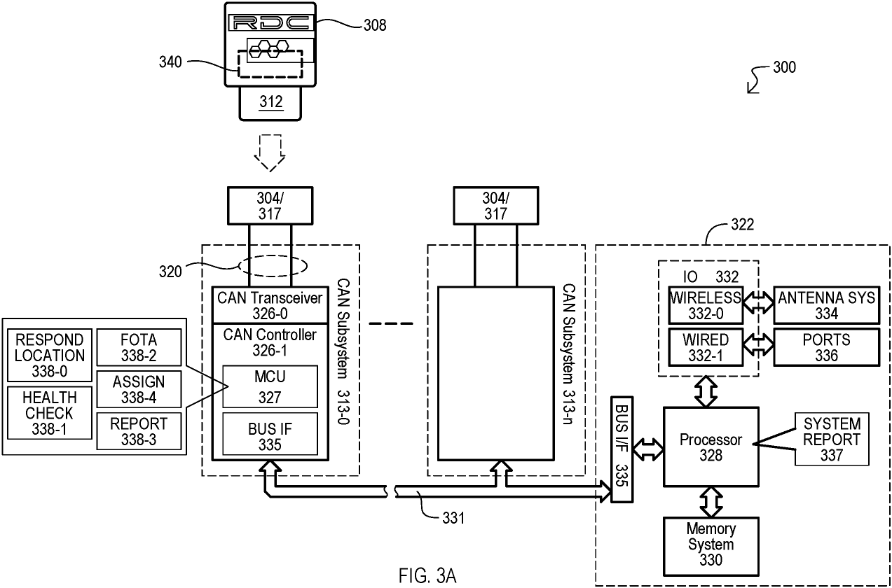

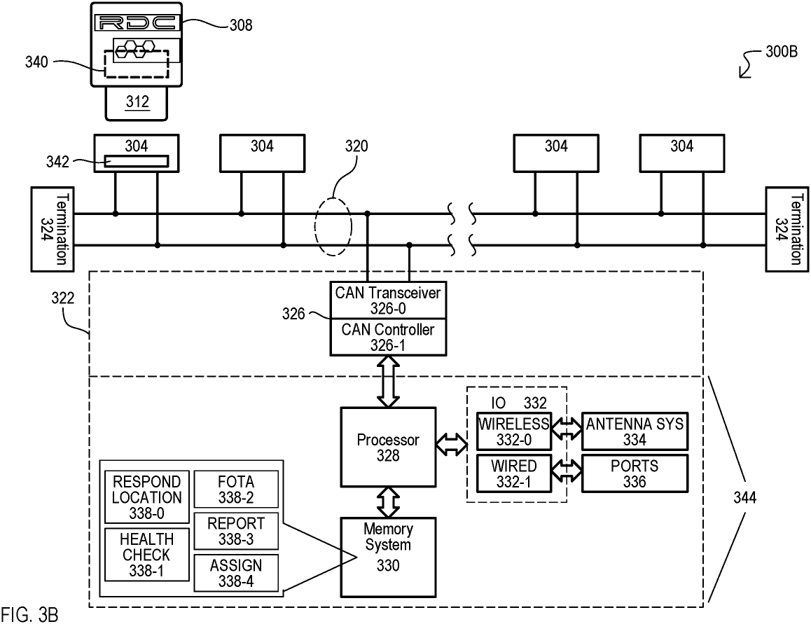

As shown by 113-0, each port subsystem (113-0 to -9) can include electronic components for controlling an inserted scanner (108-0/1). Various functions of port subsystems (113-0 to -9) are described herein with reference to FIG. 3A.

FIG. 1E is a side cross sectional view of a system 102E according to an embodiment. FIG. 1E can be a view taken along line E-E of FIG. 1B. FIG. 1E shows wireless charging systems 103, which can wirelessly charge devices through a surface 106.

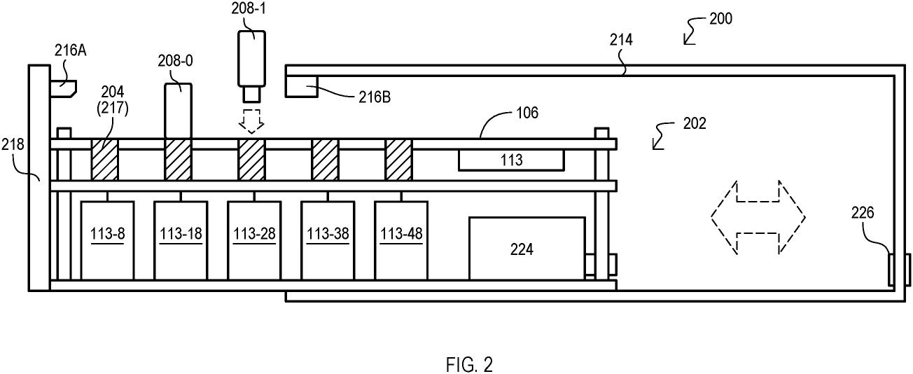

FIG. 2 is a side, cross sectional view of a system 200 according to an embodiment. A system 200 can include a scanner holder 202 and a receiver structure 214. A scanner holder 202 can receive scanners at ports as described herein. A receiver structure 214 can interface with a scanner holder 202 to prevent access to scanners 208-0/1 connected to the scanner holder 202. In the embodiment shown, a scanner holder 202 and receiver structure 214 can form a drawer-like structure in which a scanner holder 202 can slide into a receiver structure 214. However, this should not be construed as limiting. Alternate embodiments can include any suitable structures for preventing physical access to scanners 208-0/1, including but not limited to: a lockable cover, lid or bar-like structures.

A scanner holder 202 can include structures described for other embodiments herein, including a surface 106 in which are set a number of ports 204. Ports 204 can include port connectors 217 to make a physical connection with scanners (two shown as 208-0/1). In some embodiments, a scanner holder 202 can include any or all features shown in FIGS. 1A and 1E.

Referring still to FIG. 2, in the embodiment shown a scanner holder 202 can include a lock portion 216A, a front 218, port subsystems (113-8, -18, -28, -38, -48) and a power supply 224. A lock portion 216A can engage with a corresponding lock portion 216B of receiver structure 214 to lock the system 200, preventing access to scanners 208-0/1 stored within. A front 218 can close an opening of receiver structure 214 when the system 200 is locked. However, alternate embodiments may not include a front plate 218, depending upon the receiver structure 214. In some embodiments, a front plate 218 can include a transparent window. A power supply 224 can provide power to a scanner holder 202. In some embodiments, a power supply 224 can include a power storage device, such as a battery or supercapacitor to provide backup power in the absence of main power. In some embodiments, a scanner holder 202 can interface with a power connector 226 of the receiver structure 214 to power and/or charge the scanner holder 202.

FIG. 3A is a block schematic diagram of a system 300 according to an embodiment. A system 300 can include a number of ports 304, corresponding CAN subsystems 313-0 to 313-n, system bus 331, and controller 322. Ports 304 can interface with scanners (one shown as 308), and in the embodiment shown, can include a connector 317 to enable a physical connection with a scanner 308. Scanners 308 can be any suitable scanner, and in some embodiments, can be OBD type dongle scanners. In some embodiments, scanners 308 can include firmware 340 stored in nonvolatile memory for executing various functions of the scanner 308. A scanner 308 can have a connector portion 312 compatible with a port 304, as described herein and equivalents.

Each port 304 can be connected to a CAN subsystem (313-0 to -n) by a CAN bus 320. A CAN subsystem (313-0 to -n) can include a CAN transceiver 326-0 and CAN controller 326-1. A CAN transceiver 326-0 can generate and detect signals compatible with a CAN related standard, including but not limited to an ISO-15765 standard. A CAN controller 326-1 can include a microcontroller (MCU) 327 with a bus interface (IF) 335.

In some embodiments, MCU 327 can include instructions and one or more processors for executing various operations. Such operations can include, but are not limited to, a respond location operation 338-0, a health check operation 338-1, a firmware check/update operation 338-2, a reporting operation 338-3, and an assignment 338-4. In a respond location operation 338-0, MCU 327 can respond to requests generated by scanners 308 with a response that includes an identifier for the system 300. From such a response, a scanner 308 can identify its location as within the system 300 (i.e., connected to a particular port 304). Operations can also include a health check 338-1. A health check operation can examine requests received from a scanner 308 and/or generate requests to a scanner 308 to evaluate if the scanner is operating properly. A MCU 327 can receive and transmit signals on the corresponding CAN bus 320 via CAN transceiver. Data can be transmitted and received in a suitable format (e.g., data frames), and MCU 327 can deprocess (e.g., deframe) such data.

A firmware check/update operation 338-2 can determine if a scanner firmware 340 is up to date, and in some embodiments, can update the firmware 340 to a newer version if it is out of date. In some embodiments, a firmware check/update operation 338-2 can be a firmware-over-the-air (FOTA) type operation. A FOTA type operation can include an MCU 327 contacting, or enabling a scanner 308 to contact, a remote server having firmware data. In some embodiments, MCU 327 can contact a server via controller 322. If firmware is not current, a most recent version can be downloaded from the server and programmed into the scanner 308. A firmware update operation can check/update operation 338-2 can include communications over a system bus 331 and/or wireless communications for scanners 308 having wireless capabilities.

A reporting operation 338-3 can include a CAN subsystem (313-0 to -n) reporting data for each scanner 308 connected to the system 300 or to a controller 322 or other larger system (such as an inventory tracking/processing server system). Such an action can include a CAN subsystem receiving and/or requesting data for an attached scanner, and formatting and transmitting such data to a larger system over a wired and/or wireless connection.

In an assignment operation, a system 300 can be unlocked to make a scanner 308 physically accessible. A scanner 308 can then be assigned to an object, such as a vehicle or a person. In some embodiments, an assignment can include a CAN subsystem (313-0 to -n) communicating with controller 322. Resulting assignment information can be store in a controller 322 and/or forwarded to a larger system reporting operation 337 or the like.

A controller 322 can be in communication with CAN subsystems (313-0 to -n) over a system bus 331. System bus 331 can take any suitable form, and in some embodiments can be a serial bus such as an I²C type bus. A controller 322 can include a bus IF circuit 335, a processor section 328, a memory subsystem 330, IO circuit 332, antenna system 334, and communication ports 336. In some embodiments, bus IF circuit 335 can be an I²C type interface. A serial bus IF circuit 335 can receive and transmit data values between controller 322 and CAN subsystems (313-0 to -n).

A processor section 328 can include one or more processors that execute processes indicated by stored instructions (e.g., code including firmware). In some embodiments a processor section 328 can execute instructions stored in memory subsystem 330. A memory subsystem 330 can include nonvolatile and/or volatile storage for performing various controller functions. Such controller functions can include, but are not limited to, a system report operation 337. A system report operation 337 can report status and locations of scanners 308 currently stored by the system 322 to a larger system.

IO circuits 332 can include circuits that can enable system 300 to communicate with other systems. IO circuits 332 can include wireless 332-0 and/or wired IO circuits 332-1. Wireless IO circuits 332-0 can take any suitable form, including but not limited to: BT, one or more IEEE 802.11 wireless standards, or any suitable mobile technology (e.g., 3G, 4G, 5G). Wired IO circuits 332-1 can include any suitable wired communication method, including serial transmissions, such as USB, SPI, CAN, I²C, or PCI Express, as but a few of many possible examples. Wireless IO circuits 332-0 can be connected to an antenna system 334 and wired IO circuits 332-1 can be connected to one or more IO ports 336.

In some embodiments, all or a portion of a controller 322 can be located on a controller device separate from scanner holder (e.g., 102, 202). As but one example, a scanner holder can include a serial bus interface circuit 326 that connects to a controller device 344, which may not be part of a scanner holder.

FIG. 3B is a block schematic diagram of a system 300B according to another embodiment. A system 300B can include items like those of FIG. 3A, and such like items are referred to by the same reference character. A system 300B can differ from that of FIG. 3B in that multiple ports can be connected to a same bus. A system 300B can include a number of ports 304, a serial bus 320, and a controller 322. Ports 304 can enable a physical connection with scanners (one shown as 308). A serial bus 320 can enable serial communications between connected scanners 308 and controller 322. In some embodiments, a serial bus 320 can be compatible with a CAN bus standard. In some embodiments, serial bus 320 can include bus terminations 324. Terminations can provide suitable impedance values to reduce signal reflection and ensure high performance.

In some embodiments, ports 304 can include a position indicator 342. A position indicator 342 can identify a particular port. A position indicator 342 can generate one or more electronic signals which can be received by controller 322. In some embodiments, a position indicator 342 can be activated when a scanner 308 is attached (e.g., inserted in) to a port 304. A position indicator 342 can take any suitable form, including a scan code that is generated as a controller 322 periodically scans the ports 304. A position indicator 342 can transmit electronic signals on lines separate from the serial bus 320 or can use the serial bus 320 for such transmissions. In addition or alternatively, a position indicator 342 can indicate to a controller 322 when a scanner is inserted.

A controller 322 can include a serial bus IF circuit 326, a processor section 326, a memory subsystem 330, input/output (IO) circuit 322, and antenna system 334, and communication ports 336. A serial bus IF circuit 326 can take the form of any of those described herein, and equivalents, including a CAN transceiver 326-0 and CAN controller 326-1. A serial bus IF circuit 326 can receive data values from processor section 326 and can transmit such data on serial bus 320 in a suitable format (e.g., data frames), and can receive serial data received on serial bus 320, and deprocess (e.g., deframe) such data for input to processor section 328.

A processor section 328 can include one or more processors that execute processes indicated by stored instructions, which can be stored in memory system 330. In some embodiments, memory system 330 can include instructions for processor section 328 for executing various operations. Such operations can include, but are not limited to, a respond location operation 338-0, a health check operation 338-1, a firmware check/update operation 338-2, a reporting operation 338-3, and an assignment 338-4. Such operations can be the same as, or equivalent to those described in FIG. 3A.

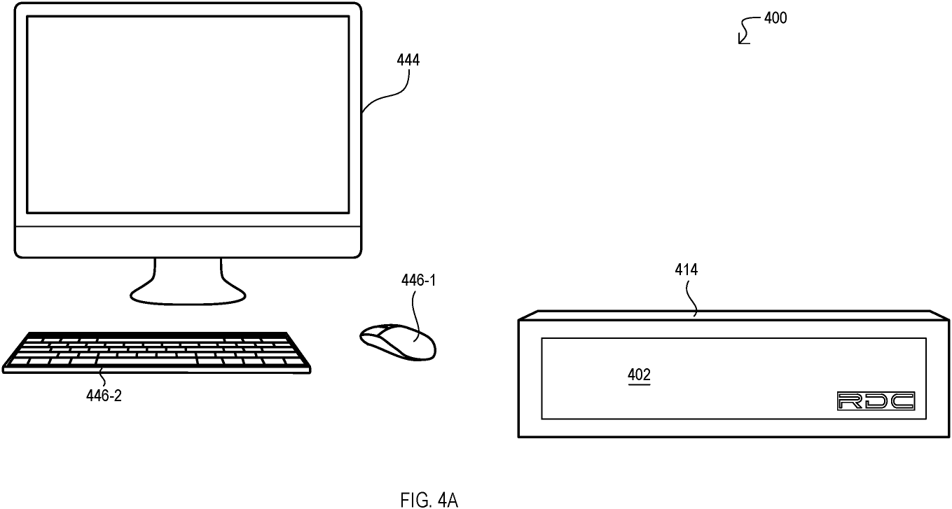

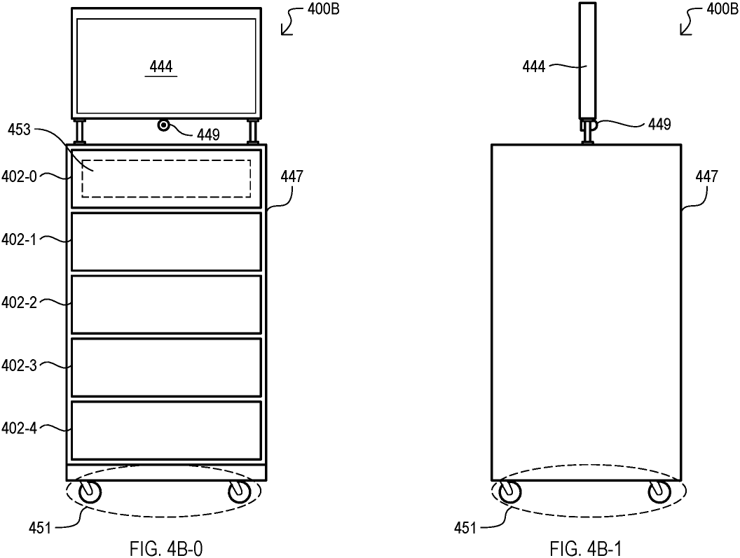

FIG. 4A is a diagram of a system 400 according to another embodiment. A system 400 can include a scanner holder 402 and receiver structure 414, and a controller device 444. A scanner holder 402 can store multiple scanners as described herein and equivalents, and in conjunction with receiver structure 414, prevent access to scanners by one or more locking mechanisms. A scanner holder 402 can perform some or all of the controller functions described herein.

In addition or alternatively, a controller device 444 can perform some or all of the controller functions described herein. A controller device 444 can be a computing device in communication with a scanner holder 402 over a wired and/or wireless connection. A controller device 444 can be any suitable device, including but not limited to: a desktop computing system, a laptop computing system, a tablet computing system and/or a handheld computing system. In the embodiment shown, input devices 446-0/1 can be included for the controller device 444.

In some embodiments, a controller device 444 can be in communication with a larger system (e.g., server) to provide status information for scanners connected to scanner holder 402.

FIG. 4B-0 and 4B-1 are diagrams showing a system 400B according to another embodiment. FIG. 4B-0 is a front view of a system 400B. FIG. 4B-1 is a side view of a system 400B. A system 400B can include a plurality of scanner storage systems 402-0 to -4 located in a movable structure 447. In the embodiment shown, a structure 447 can be a cabinet structure and scanner storage systems (402-0 to -4) can be drawers that can be locked in cabinet structure 447. In some embodiments, any or all scanner storage systems (402-0 to -4) can advantageously include a transparent front 453 to enable easy viewing of scanners inserted in the system. A movable structure 447 can include a movement system 451 to enable a system to be physical moved to different locations. A movement system 451 can take any suitable form, including unpowered systems (e.g., casters or the like) as well as powered systems (e.g., motorized wheels).

In the embodiment shown, system 400B can include a controller device 444 located on a top surface, which can include a display and/or one or more input systems. In addition, a system 400B can also include a camera system 449. In some embodiments, a camera system 449 can be used in security functions, including biometrics used for unlocking a system and/or assignment operations. Further, a camera system 449 can be part of, or connected to a larger security system of an operating site.

While embodiments can include systems for securely storing scanner devices, embodiments can also include larger tracking systems including such scanner storing systems.

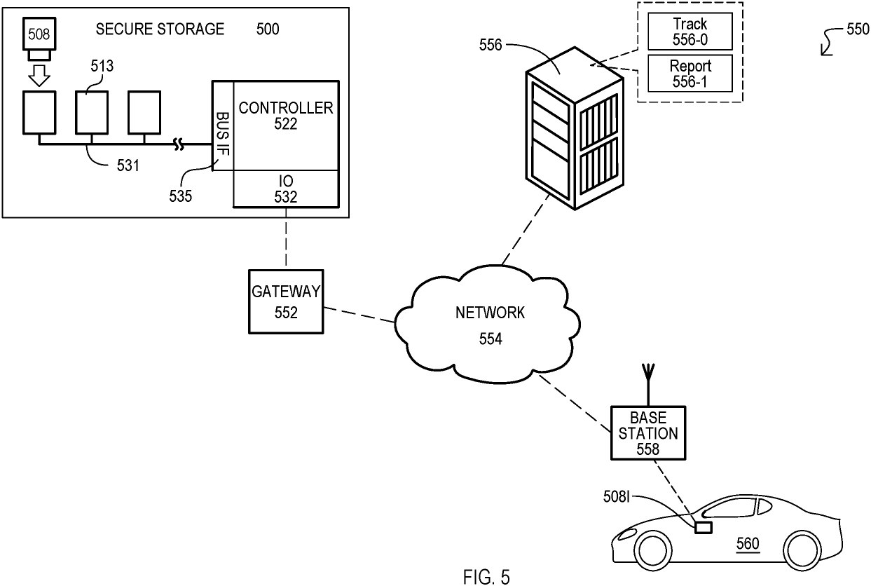

FIG. 5 is a diagram of a tracking system 550 according to an embodiment. A tracking system 550 can include a secure storage system 500, a network 554 and a server 556. A secure storage system 500 can receive scanners 508 at subsystems 513 connected to a bus 531, which can be a serial bus. A controller 522 can communicate with subsystems 513 over bus 531 via an interface 535. In some embodiments, subsystems 513 can be MCU based subsystems as described herein, or equivalents. A controller 522 can also communicate with server 556 over network 554. A system 500 can take the form of any of those disclosed herein and equivalents.

In the embodiment shown, controller 522 can communicate with network 554 via a gateway device 552. A network 554 can include multiple networks including the Internet.

A server 556 can include computing devices for executing various operations, including but not limited to tracking operations 556-0 and reporting operations 556-1. Tracking operations 556-0 can include receiving transmissions from secure storage system 500 and scanners 508I installed at other locations (e.g., vehicles). A tracking operation 556-0 can receive transmissions from scanners, including scanners installed in a vehicle 508I. From such information a tracking operation 556-0 can track a vehicle data provided by a scanner, including vehicle location for scanners having a positioning system. A reporting operation 556-1 can include reporting data for all scanners in a tracking system 550.

A tracking system 550 can further include scanners 508I installed in vehicles 560. Installed scanners 508I can transmit data from a corresponding vehicle 560 to server 556. In the embodiment shown, an installed scanner 508I can transmit data over a cellular network that can include a base station 558 in communication with network 554.

In operation, scanners 508 can be programmed to communicate with server 556. Such a program operation can occur at secure storage system 500 or at another location or device. A scanner 508 can be securely stored (e.g., locked) in a storage system 500 until needed. When a scanner is needed, a storage system 500 can be unlocked, and a scanner 508 assigned to a vehicle. When a vehicle is to leave a system 550, the scanner 508I can be returned to secure storage system 500.

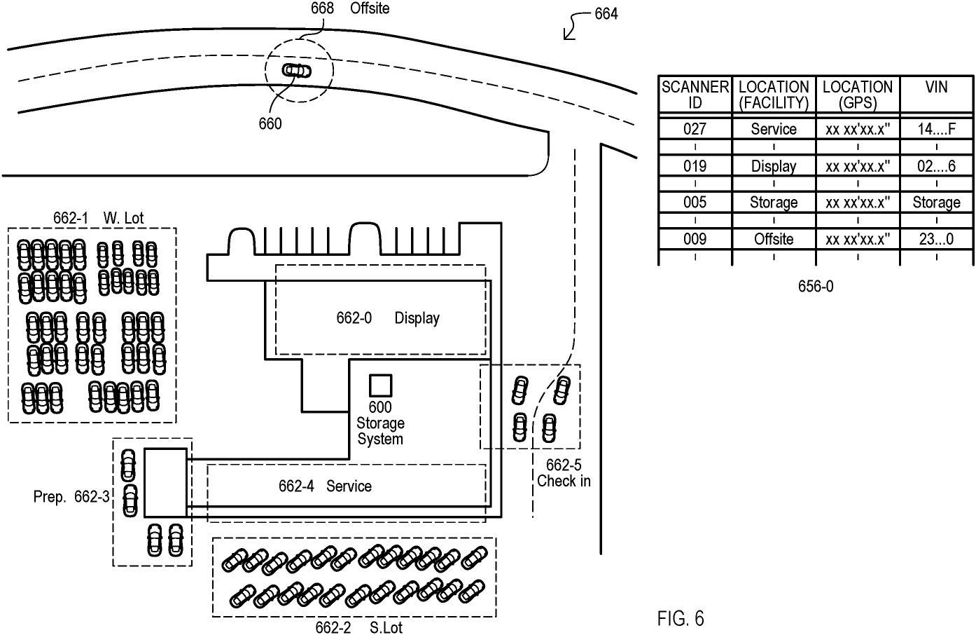

FIG. 6 is a diagram showing a location system operation according to an embodiment. FIG. 6 shows a diagram of an operating site 664 for vehicles (one shown as 660), as well as one example of tracking system data 656-0. In a tracking operation, scanners can be checked out of a secure storage system 600 and connected to an assigned vehicle. Scanners can transmit location data (and other data) for reception by a tracking system. From such location data, a tracking system can identify a location of the scanner (and hence a location of the assigned vehicle). In some embodiments, a tracking system can derive a location by comparing a location value (e.g., GPS or equivalent) to site locations. In some embodiments, scanners can receive and provide additional location data from site located devices, such as beacons, or the like.

In the embodiment shown, operating site can include locations 662-0 to 662-5, with locations outside of facility being offsite locations. In some embodiments, scanner locations can be superimposed on a map displayed by a computing device in communication with a system.

While the above embodiments have disclosed methods in conjunction with devices as systems, additional methods will now be described with reference to flow diagrams.

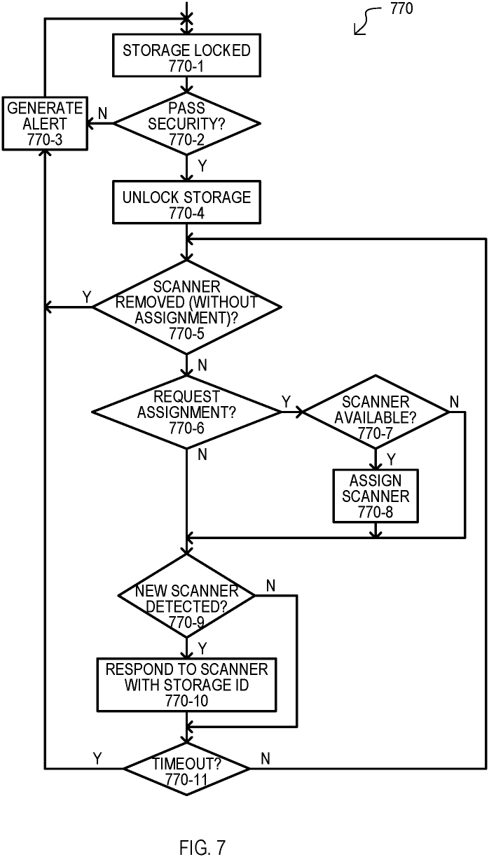

FIG. 7 is a flow diagram of a method 770 of operating a secure scanner storage system according to an embodiment. A method 770 can include having the system in a locked state 770-1. Such an action can include having scanners connected to a scanner holder while not being physically accessible. In some embodiment, scanners can be contained in an enclosure.

A method 770 can include a security check 770-2 to access stored scanners. If access is attempted, but a security test is taken and not passed (N from 770-2), an alert can be generated 770-3. If a security test is passed (Y from 770-2), a storage system can be unlocked 770-4. A security test can include any suitable test, including one or more biometric tests (e.g., fingerprint, facial recognition), password test, and/or key-type device (e.g., physical key, RFID). Unlocking a storage system 770-4 can make scanners available for assignment.

In the embodiment shown, a method 770 can detect when a scanner is removed without being assigned (e.g., removed in an unauthorized manner). As but one example, a storage system can detect when a scanner is removed and can determine if it has been assigned. If a scanner has been removed without being properly assigned (Y from 770-5), an alert can be generated 770-3. Alternate embodiments may not include detecting when a scanner is removed.

A method 770 can determine when a scanner assignment is requested 770-6. Such an action can include a user accessing an application on, or in communication with, a secure storage system. If a request for a scanner assignment is made (Y from 770-6), a method 770 can determine if a scanner is available 770-7. Such an action can include accessing a database to determine if a scanner is available. If a scanner is available (Y from 770-7), the scanner can be assigned 770-8. In some embodiments, such an action can include entering data into an application executed by a system. In addition or alternatively, such an action can include connecting the selected scanner to a vehicle, and allowing the scanner to report the vehicle’s information.

In some embodiments, a method 770 can detect when new scanners are received (e.g., inserted into scanner holder) 770-9. Such an action can include a scanner holder automatically detecting the attachment of the scanner. However, in other embodiments, such an action can include a user entering data for the scanner into a tracking system, or the like. If a new scanner is detected (Y from 770-9), a communication can be generated for the scanner that provides a storage ID. A storage ID can be code that identifies the secure storage device. In some embodiments, such a code can be provided in a response generated in response to a request from a scanner.

In some embodiments, a method 770 can provide a limited amount of time that a secure storage system is left in an unlocked state 770-11. If a secure storage remains unlocked beyond a timeout period (Y from 770-11), an alert can be generated 770-3. During the timeout period (N from 770-11), a method 770 can continue to enable the assignment of available scanners and/or detect if a scanner is removed without assignment (return to 770-5).

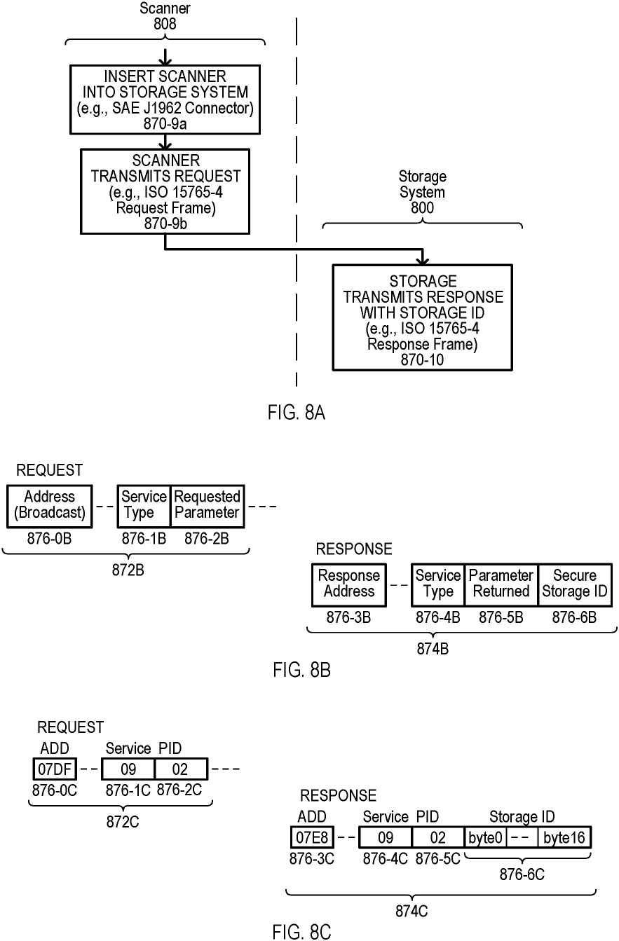

FIGS. 8A to 8C are diagrams showing communications between a scanner and a storage system according to various embodiments. FIG. 8A is a diagram showing operations performed by a scanner 808 and storage system 800. A scanner 808 can be inserted into a storage system 870-9a. In some embodiments, such an action can include inserting a male connector compatible with the SAE J1962 standard into a compatible female socket. A scanner 808 can transmit a request 870-9b. In some embodiments, such an action can include a scanner 808 automatically transmitting a request data frame upon detecting power at the connector (i.e., detecting a bus). In some embodiments, a request can be a request data frame can be compatible with the ISO 15765-4 standard.

Upon receiving a request, a storage system 800 can generate a response that includes a storage ID 870-10. A storage ID can identify the storage system, and can be included in transmissions from a scanner 808. In some embodiments, a response can be a response data frame can be compatible with the ISO 15765-4 standard.

FIG. 8B is a diagram showing a request data frame 872B and response data frame 874B according to an embodiment. A request data frame 872B can have various fields, including but not limited to, an address field 876-0B, a service type field 876-1B, and requested parameter field 876-2B. An address field 876-0B can indicate a destination for the request, and in some embodiments can include a broadcast value. A broadcast value can be a predetermined value, or range of values that a storage system can monitor for, and in some cases, respond to. A service type field 876-1B can indicate a type of response, or set of responses requested. A requested parameter field 876-2B can indicate one or more particular parameters that a scanner wishes to receive from a response. In some embodiments, a requested parameter field 876-2B can be a storage system ID value.

A response data frame 874B can be returned by a storage system in response to request data frame 872B. A response data frame 874B can have various fields, including but not limited to, an address field 876-3B, a service type field 876-4B, a returned parameter field 876-5B and a parameter value 876-6B. An address field 876-3B can be a destination address that indicates the scanner transmitting the request frame 872B. In some embodiments, such a value can be derived from the request data frame 872B. A service type field 876-4B can indicate a type of response, or set of responses requested, and in some embodiments can be the same as that included in the request data frame. A returned parameter field 876-5B can indicate a parameter being returned, and in some embodiments can be the same as that included in the requested parameter field 872-2B of the request data frame 872B. A parameter value 875-6B can include a secure storage ID that can identify the storage system to which the scanner is connected.

FIG. 8C is a diagram showing a request data frame 872C and response data frame 874C according to another embodiment. Request and response data frames (872C/874C) can have data fields as described for FIG. 8B, but can be compatible with the ISO-15765-4 standard. Fields 876-1C/876-5C can be parameter ID (PID) values, and a returned parameter can have the format of a 17-byte vehicle identification number (VIN). When a scanner transmits data, it can include such a value which can be recognized by a tracking system as corresponding to the storage system.

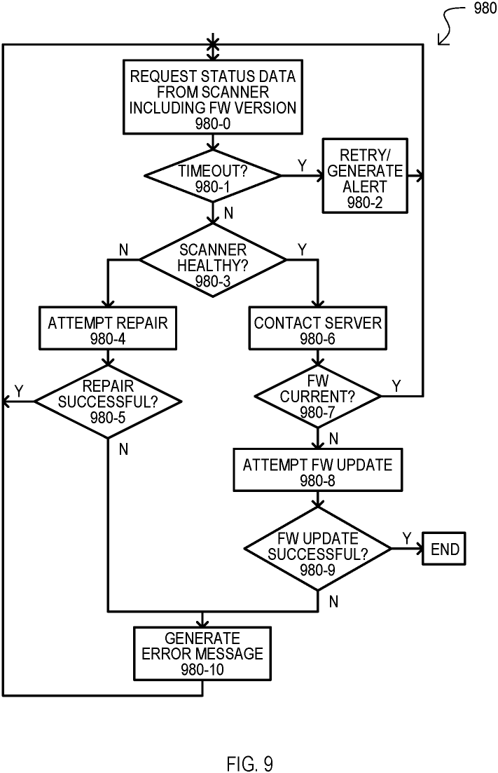

FIG. 9 is a flow diagram of a method 980 that can be executed by a storage system according to an embodiment. A method 980 can include requesting status data from a scanner including a current firmware (FW) version 980-0. Such an action can include issuing a request on a bus to which the scanner is attached. In some embodiments, such an action can include generating one or more request data frames with an address corresponding to a scanner. If status data is not received within a predetermined time period (Y from 980-1), a method 980 can retry and/or generate an alert 980-2, indicating the scanner is not responsive.

If a scanner returns status information (N from 980-1), a method 980 can determine if a scanner is healthy (i.e., operating properly) 980-3. Such an action can include comparing returned values to a set of expected values. In some embodiments, such an action can include testing one or more wireless transmission capabilities of a scanner. If a scanner is determined not to be healthy (N from 980-3), a system can attempt a repair 980-4. Such an action can include any suitable repair processes, including but not limited to reinstalling firmware and/or restarting the scanner device. If a repair is successful (Y from 980-5), a method 980 can return to start (e.g., repeat process with a next scanner). If a repair is not successful (N from 980-5), a method 980 can generate an alert 980-10.

If a scanner is determined to be healthy (Y from 980-3), a method 980 can include a firmware check operation. A firmware check operation can be performed by the scanner or by the storage system. Such an operation can include contacting a server 980-6. Such an action can include contacting a server for the manufacturer of the scanner to find a most recent version number of the firmware for the scanner. If the firmware is current (Y from 980-7) a method 980 can return to 980-0 (e.g., repeat process with a next scanner).

If the firmware is not current (N from 980-7) a method 980 can attempt a firmware update 980-8. Such an operation can include downloading and installing the most current version of firmware in the scanner. In some embodiments, such an action can include downloading firmware from the manufacturer server. However, such an action can also include installing firmware stored in a storage system or tracking system that has been previously downloaded. If a firmware update is successful (Y from 980-9), a method 980 can return to 980-0 (e.g., repeat process with a next scanner). If a firmware update is not successful (N from 980-9), a method 980 can generate an alert 980-10.

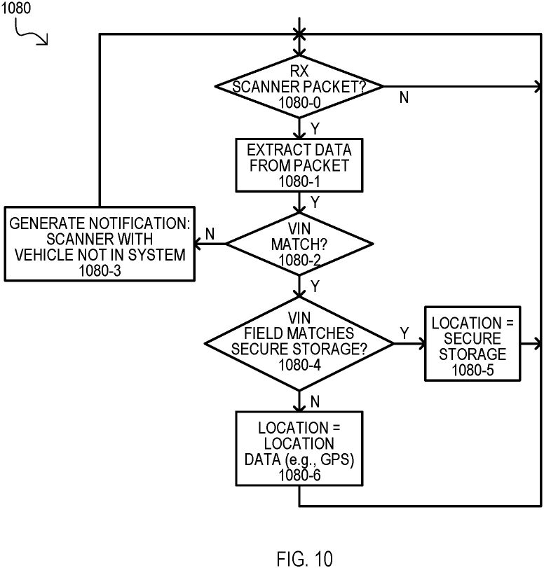

FIG. 10 is a flow diagram of a method 1080 that can be executed by a tracking system according to an embodiment. A method 1080 can include receiving a scanner packet 1080-0. A scanner packet 1080-0 can be a packet with data originating from a scanner, the packet having a destination address corresponding to the tracking system (e.g., tracking system server). A scanner packet 1080-0 can be transmitted according to any suitable protocol, according to the available network. A scanner packet 1080-0 can be generated by a scanner, or can be generated by another system for a scanner.

If a packet is received (Y from 1080-0), a method 1080 can extract data from the packet 1080-1. Such an action can include any packet processing steps suitable for the protocol. In some embodiments, an application resident on a tracking server system can perform such packet processing. From receive scanner data, a method 1080 can determine if a VIN value received in the packet matches any of those in the system 1080-2. In some embodiments, such an action can include comparing a 17-byte value to database containing VIN values for a tracking system. Such VIN values can include VIN values corresponding to storage systems, as described herein and equivalents. If there is no VIN match (N from 1080-2), a method 1080 can generate a notification that the scanner is with a vehicle that is not in the system.

If the VIN is in the system (Y from 1080-2) and matches that for a secure storage system (Y from 1080-4), a method in set a location for the scanner as being in the storage system 1080-5. If the VIN is in the system (Y from 1080-2) but does not match that for a secure storage system (N from 1080-4), a method 1080 can determine a scanner location according to position data (e.g., GPS) provided in the scanner data packet 1808-6.

It is noted that the various methods and applications shown herein are provided by way of example, and should not necessarily be construed as limiting. Further, while some embodiments are presented in terms of systems and methods related to automobiles, it is understood that the invention disclosed is anticipated for use with any object that could be subject to repair or other alteration. Accordingly, the invention could be used in conjunction with other types of vehicles, including aircraft, rail cars, construction equipment, military equipment, or any other suitable product subject to repair or alteration.

It will be apparent to those skilled in the art that various modifications and variations can be made without departing from the spirit or scope of the invention. Thus, it is intended that the disclosed embodiments cover modifications and variations that come within the scope of the claims that eventually issue in a patent(s) originating from this application and their equivalents. In particular, it is explicitly contemplated that any part or whole of any two or more of the embodiments and their modifications described above can be combined in whole or in part.

It should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention. It is also understood that other embodiments of this invention may be practiced in the absence of an element/step not specifically disclosed herein.

What is claimed is:

1. A method, comprising:
providing a plurality of physical ports for on-board diagnostic (OBD) type scanners in a secure storage system, the physical ports not being accessible when the secure storage system is locked;
by operation of an unlocking procedure, unlocking the secure storage system to enable physical access to the plurality of physical ports;
receiving at least one on-board diagnostic (OBD) type scanner at one of the physical ports of the secure storage system; and
in response to a predetermined request data frame from the at least one OBD type scanner, generating a response data frame for reception by the OBD type scanner that includes at least one data field that identifies the secure storage system.

2. The method of claim 1, wherein providing the plurality of physical ports includes providing no less than ten female connectors compatible with a SAE J1962 standard.

3. The method of claim 1, wherein the unlocking procedure includes at least one biometric authentication.

4. The method of claim 1, wherein unlocking the secure storage system to enable access includes unlocking a drawer that slides open to reveal the physical connectors.

5. The method of claim 1, further including:
requesting configuration data from one OBD type scanner, including a firmware version;
determining if the firmware version is a latest version; and
if the firmware version is not the latest version, updating the firmware of the OBD type scanner.

6. The method of claim 5, wherein:
updating the firmware includes contacting a server remote from the secure storage system,
downloading the latest version of the firmware,
transmitting the latest version of the firmware to the one OBD type scanner.

7. The method of claim 1, wherein:
requesting operational data from one OBD type scanner; and
from the operational data determining if the one OBD type scanner is operating properly.

8. A system, comprising:
a storage system that includes
a scanner holding member having
a plurality of physical ports
a serial bus coupled to the physical ports, and
at least one subsystem coupled to the serial bus and configured to receive a predetermined request data frame received at a physical port, and in response, generate a response data frame on the serial bus that includes at least one data field that identifies the storage system,
a receiving member configured to receive the scanner holding member, and
a lock configured to lock the scanner holding member in the receiving member to prevent physical access to the physical ports; and
a plurality of on-board diagnostic (OBD) type scanners each configured to generate request data frames, and each including a first type connector configured to connect to the physical ports.

9. The system of claim 8, wherein:
the scanner holding member and receiving member comprise a drawer structure; wherein
in an unlocked state, the scanner holding member slides out of the receiving member, and
in a locked state, the scanner holding member inserted into the receiving member and prevented from being removed from the receiving member by the lock.

10. The system of claim 8, wherein:
the at least one subsystem is configured to, in response to the predetermined request data frame, generate a response data frame having an identification field corresponding to a vehicle identification number (VIN) that is filled with an identification value for the storage system.

11. The system of claim 8, wherein:
the OBD type scanners include firmware; and
the at least one subsystem is further configured to
determine if firmware versions for OBD type scanners connected at the physical ports is up to date, and
if a firmware version for an OBD type scanner is not up to date, update the firmware for the OBD type scanner.

12. The system of claim 11, wherein:
the at least one subsystem is further configured to
contact a remote server to determine a most recent firmware version for the OBD type scanner, and
download the most recent firmware version from the remote server.

13. The system of claim 8, wherein:
the at least one subsystem is further configured to
request operational data from OBD type scanners connected at the physical ports, and
from the operational data, determine if the OBD type scanners connected at the physical ports are operating properly.

14. The system of claim 8, wherein the OBD type scanners include wireless transmission circuits configured to transmit data received at the first type connectors.

15. A device, comprising:
a scanner holding member that includes
a scanner receiving surface having ports set therein, each port configured to physically connect to a removable on-board diagnostic (OBD) type scanner;
a serial bus coupled to the physical ports,
at least one system configured to
receive a predetermined request data frame received at a physical port, and in response, generate a response data frame on the serial bus that includes at least one data field that identifies the storage system, and
generate requests for information from ODB scanners connected to the ports; and
a receiving member configured to receive the scanner holding member, and
a lock configured to lock the scanner holding member in the receiving member to prevent physical access to the physical ports.

16. The device of claim 15, wherein:
the scanner holding member and receiving member comprise a drawer structure; wherein
in an unlocked state, the scanner holding member slides out of the receiving member, and
in a locked state, the scanner holding member is inserted into the receiving member and prevented from being removed from the receiving member by the lock.

17. The device of claim 15, wherein:
the ports are compatible with a SAE J1962 standard; and
the at least one subsystem is configured to process and generate data frames compatible with an ISO 15765 standard.

18. The device of claim 15, wherein:
the at least one subsystem includes communication circuits configured to communicate with a remote server over a network connection.

19. The device of claim 15, wherein:
the at least one subsystem is configured to
request configuration data from an OBD type scanner connected to a port, including a firmware version;
determine if the firmware version is a latest version; and
if the firm ware version is not the latest version, update the firmware of the OBD type scanner.

20. The device of claim 15, wherein:
the at least one subsystem is configured to, in response to the predetermined request data frame, generate a response data frame having an identification field corresponding to a vehicle identification number (VIN) that is filled with an identification value for the storage system.
